(19) United States
(12) Patent Application Publication
(10) Pub. No.: US 2004/0245690 A1
(43) Pub. Date: Dec. 9, 2004

(54) Hydro-mount

(76) Inventors: Gerold Winkler, Birkenau (DE); Franz Ridderskamp, Weinheim (DE)

Correspondence Address: HARNESS, DICKEY & PIERCE, P.L.C., P.O. BOX 828, BLOOMFIELD HILLS, MI, 48303, US

(21) Appl. No.: 10/784,116

(22) Filed: Feb. 20, 2004

(30) Foreign Application Priority Data
Feb. 21, 2003 (DE) 10307680.8

(51) Int. Cl. F16M 5/00

(52) U.S. Cl. 267/140.13

(57) ABSTRACT

A hydro-mount comprising a support bearing and an end bearing which support each other by means of a spring element made of a resilient material. The spring element encloses a work space filled with a damping liquid. The spring element is made of silicone and, on its side facing the work space, is provided with a protective layer consisting of a material that is resistant to the damping liquid and is impervious thereto.

### CROSS-REFERENCE TO RELATED APPLICATIONS

This application claims the benefit of DE 103 07 680.8-12, filed Feb. 21, 2003. The disclosures of the above application is incorporated herein by reference.

### FIELD OF THE INVENTION

The invention relates to a hydro-mount including a support bearing and an end bearing which support each other by means of a spring element made of a resilient material, wherein the spring element encloses a work space filled with a damping liquid.

### BACKGROUND OF THE INVENTION

Hydro-mounts are generally known, for example, from EP 0 547 287 B1. A spring element of a prior-art hydro-mount in most cases consists of natural rubber or EPDM, because these materials are heat-resistant up to a temperature of about 150° C. Exposure of these materials to temperatures above 150° C., however, results in adversely modified use properties and/or a destruction of the material.

The afore-mentioned heat resistance is insufficient especially when a hydro-mount is used as an engine mount in modern motor vehicles. In modern motor vehicles, the engine compartments are often extensively enclosed in order to reduce sound emissions from the engine compartment into the surroundings as efficiently as possible. Moreover, engine compartments are becoming smaller and smaller so as to be able to meet the increasing requirements placed on motor vehicle aerodynamics. For these reasons, high temperatures are not sufficiently kept away from the hydro-mount and dissipated to the surroundings.

Further, heat shields used to protect hydro-mounts are not satisfactory because they require additional installation space, and their separate fabrication leads to increased costs.

### SUMMARY OF THE INVENTION

The objects of the invention are to provide a hydro-mount that can be exposed to temperatures appreciably above 150° C., without adversely affecting its use properties and/or its service life, and to provide a hydro-mount that does not have larger dimensions than the common prior-art hydro-mounts.

To reach the above objectives, a spring element is made of a high temperature-resistant material, preferably a silicone elastomer. The side of the spring element faces a work space that is provided with a protective layer consisting of a material that is resistant and impervious to a damping liquid.

The spring element made of silicone can be exposed to much higher temperatures in comparison to a spring element made of, for example, EPDM without its use properties being adversely affected and/or its service life shortened. With the aid of the spring element consisting of a silicone elastomer, the hydro-mount of the present invention can be exposed to temperatures up to 200° C., and can be used as an engine mount in very compact and/or fully enclosed engine compartments. The protective layer is provided because the commonly available, inexpensive silicone materials are not resistant to the damping liquid present within the work space of hydro-mounts. The damping liquid in most cases consists of a mixture of glycol and water. Without a protective layer, this mixture would penetrate into the surfaces of silicone spring elements and, during use, would diffuse through them. The use of special silicone blends and/or a special damping liquid to avoid these problems is unsatisfactory from an economic standpoint.

The protective layer is provided for the purpose of protecting the surface of the silicone spring element facing the work space. The protective layer can be made of a material usually employed for spring elements, for example natural rubber or EPDM, because these materials have already been shown to be suitable for fabricating hydro-mount spring elements. That is, these materials are resistant to the damping liquid and are impervious thereto.

The protective layer is sized so that it exerts only a negligible effect on the use properties of the hydro-mount.

The spring element can be configured essentially as a truncated cone. It should be understood, however, that those skilled in the art of designing hydro-mounts can adapt the configuration and/or sizing of the spring element to any particular application in question. As far as the design and/or sizing is concerned, however, there are no pronounced differences between EPDM spring elements and silicone spring elements so that the geometries of known EPDM spring elements can be applied to silicone spring elements without making any essential design changes.

The spring element and the protective layer can be bonded by adhesion. This is advantageous in that the use properties of the hydro-mount are easier to predict because there is no mechanical interlocking between the spring element and the protective layer. The different materials constituting the spring element and the protective layer are located in clearly separated regions. There is no region wherein the material constituting the spring element and the material from which the protective layer is made exist side-by-side, for example owing to frictional interlocking.

Adhesive bonding between the spring element and the protective layer can be achieved, for example, by spraying, during a first step of the process, the thin, cup-shaped protective layer of, for example, EPDM. In a second processing step, the silicone spring element is sprayed onto the protective layer which results is adhesive bonding in the region of the two mutually facing surfaces of the protective layer and the spring element. A reversal of the processing steps whereby the silicone spring element is sprayed in the first processing step and, in a second processing step, the protective layer of a relatively harder material, for example EPDM, is sprayed onto the silicone spring element is, in general, possible, but considering that during the spraying the comparatively softer silicone would cause the thin, harder layer of EPDM to wrinkle, such a process would not be without problems.

In another embodiment, the spring element and the protective layer can be connected to each other without adhering. That is, the spring element and the protective layer can be connected non-adhesively. In contrast to the adhesive connection between the spring element and the protective layer, the advantage of such an embodiment is that the spring element and the protective layer are fabricated separately and are assembled during the installation of the hydro-mount.

According to an another advantageous embodiment of the present invention, the protective layer completely covers the entire surface of the spring element facing the work space. Moreover, a partly touching protective layer can provide additionally improved use properties.

The protective layer preferably consists of EPDM. This provides an advantage in that, compared to a protective layer of natural rubber, EPDM is somewhat more heat resistant and, as a result, the entire hydro-mount can be exposed to higher temperatures. At any rate, the temperature of the protective layer is below its critical range of 120 to 150° C. even when the spring element is externally exposed to a temperature of up to 200° C. The spring element, therefore, is responsible for the good use properties of the hydro-mount, namely its high heat resistance and advantageous spring action. The protective layer also provides sufficient resistance to the damping liquid.

The ratio of the thickness of the spring element at its thickest point to the thickness of the protective layer, both considered in the longitudinal direction of the hydro-mount, can amount to at least 2. Preferably this ratio amounts to at least 8. The smallest possible thickness of the protective layer depends exclusively on the resistance of the protective layer to the damping liquid. The lower the thickness of the protective layer, the smaller is the effect of the protective layer on the use properties of the spring element

Preferably, the protective layer has a thickness from 1 to 4 mm.

The protective layer can have the same thickness in all parts thereof. This simplifies the fabrication of the hydro-mount, thus reducing its overall cost. Moreover, the effects of the protective layer on the use properties of the hydro-mount are then more predictable.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 depicts an embodiment of a hydro-mount according to a principle of the present invention wherein the spring element and the protective layer are adhesively bonded together.

### DETAILED DESCRIPTION OF THE PREFERRED EMBODIMENTS

The following description of the preferred embodiment(s) is merely exemplary in nature and is in no way intended to limit the invention, its application, or uses.

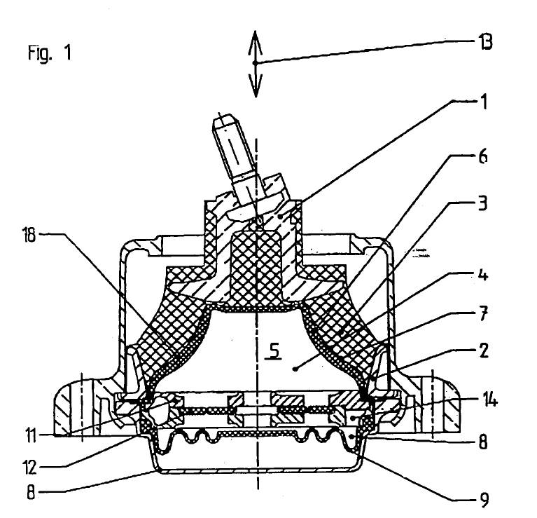

FIG. 1 shows a hydro-mount according to a principle of the present invention. The hydro-mount comprises a support bearing 1 and an end bearing 2 that support each other by means of spring element 3. Support bearing 1, end bearing 2, and an air bellows 9 that accommodates volume without pressure enclose a work space 5 and equalizing space 8 which are filled with a damping liquid 4 and are separated from each other by a partition 10. In the embodiment shown here, partition 10 consists of a jet cage 11 within which is disposed a membrane 12 capable of vibrating in a direction 13. Membrane 12 is surrounded radially on the outside by a damping channel 14 which connects the work space 5 and equalizing space 8, allowing flow to occur between them.

To damp vibrations of low frequency and high amplitude, a column of damping liquid present within the damping channel 14 is displaced back and forth between the work space 5 and equalizing space 8 in a phase opposed to the vibrations introduced. To isolate the high-frequency, low-amplitude vibrations, the membrane 12 can move within jet cage 11 back and forth in a phase opposed to the vibrations introduced. The configuration of partition 10 is not limited and can be configured in any desired manner known in the art.

Spring element 3 is made of silicone and, on a side facing work space 5, is provided with a protective layer 6 which, in this embodiment, consists of EPDM.

The surface 7 of the spring element 3 that faces the work space 5 is completely covered by, and in touching contact with, a protective layer 6. In this manner, the surface 7 of the spring element 3 that faces the work space 5 is optimally protected from exposure to the damping liquid 4, and undesirable noise during operation of the hydro-mount is prevented.

In this embodiment, the spring element 3 and protective layer 6 are adhesively connected to each other, with the protective layer of EPDM being sprayed in a first processing step. After the surface of protective layer 6 has solidified, the spring element 3 that consists of silicone is sprayed onto the protective layer 6. The spraying is carried out with the aid of an appropriate adhesion promoter.

The ratio of a thickness of the spring element 3 at its thickest point to a thickness of protective layer 6, in both cases considered in the longitudinal direction of the hydro-mount, amounts to 15, with all parts of the protective layer 6 having the same thickness.

According to the principles of the present invention, the advantages of the hydro-mount are the facts that the hydro-mount can be left exposed from the outside, for example from the engine compartment of a motor vehicle and through the spring element 3 made of silicone, to high temperatures up to 200° C., and that the spring element 3 made of silicone is neither attacked nor penetrated by the damping liquid 4. Further, in view of the fact that the protective layer 6 protects the spring element 3 from exposure to the damping liquid 4, expensive materials to protect the spring element 3 and/or a special and expensive damping liquid 4 are not necessary. Hence, the hydro-mount can be fabricated economically.

The description of the invention is merely exemplary in nature and, thus, variations that do not depart from the gist of the invention are intended to be within the scope of the invention. Such variations are not to be regarded as a departure from the spirit and scope of the invention.

1. A hydro-mount comprising:
a support bearing and an end bearing which support each other by means of a spring element comprised of a resilient material, the spring element enclosing a work space filled with a damping liquid;
wherein the resilient material is resistant to high temperatures, and
on a side of the spring element facing the work space, said spring element is provided with a protective layer comprising a material that is resistant and impervious to the damping liquid.

2. The hydro-mount according to claim 1, wherein the spring elements is comprised of a silicone elastomer.

3. The hydro-mount according to claim 1, wherein the spring elements is configured essentially in the form of a truncated cone.

4. (Currently Amended) The hydro-mount according to claim 1, wherein the spring elements and the protective layer are adhesively connected.

5. The hydro-mount according to claim 1, wherein the spring elements and the protective layer are non-adhesively connected.

6. Th hydro-mount according to claim 1, wherein the protective layer covers an entire surface of the spring elements that faces the work space and is at least in partial contact with the surface.

7. The hydro-mount according to claim 6, wherein the protective layer is in complete contact with the surface.

8. The hydro-mount according to claim 1, wherein the protective layer consists of EPDM.

9. The hydro-mount according to claim 1, wherein a ratio of a thickness of the spring elements at its thickest point to a thickness of the protective layer, both considered in the longitudinal direction of the hydro-mount, amounts to at least 2.

10. The hydro-mount according to one of claim 1, wherein the protective layer has a thickness in the range off 1 to 8 mm.

11. The hydro-mount according to one of claim 1, wherein the protective layers has the same thickness in all parts thereof.
